(19) United States
(12) Patent Application Publication
(10) Pub. No.: US 2009/0025063 A1
(43) Pub. Date: Jan. 22, 2009

(54) Role-based access control for redacted content

(75) Inventor: Kasman E. Thomas, Wilton, CT (US)

Correspondence Address: KING & SCHICKLI, PLLC, 247 NORTH BROADWAY, LEXINGTON, KY, 40507, US

(73) Assignee: Novell, Inc.

(21) Appl. No.: 11/879,714

(22) Filed: Jul. 18, 2007

(51) Int. Cl. G06F 7/04

(52) U.S. Cl. 726/4

(57) ABSTRACT

Apparatus and methods are described for accessing redacted material based on user roles. An author designates portions of content as to-be-redacted. The author establishes various users roles able to access it and defines attributes or time constraints affecting the viewing/using. Upon electronically saving the content, the to-be-redacted portion is encrypted. An intermediary, such as a keytable service, mediates access between later users and the content. Upon identification of a role of a user attempting to interact with the content, and matching the role to one of the author-established roles, the encrypted redacted portion is decrypted. In this manner, users gain access to content based only on their role. The surrounding events are also loggable, traceable, and verifiable. A monitored connection between the user and the content, as well as various user interface options, are other noteworthy features. Computer program products and computing network interaction are also defined.

### FIELD OF THE INVENTION

Generally, the present invention relates to computing environments involving access to sensitive materials. Particularly, it relates to authoring and accessing redacted content based on user roles. Various features relate to computer software products, systems for same and methods. Access indicia, monitored connections, user-interfaces, and logging, to name a few, are other noteworthy features.

### BACKGROUND OF THE INVENTION

Current security around sensitive documents (e.g., spreadsheets, PDFs, Word documents, etc.) centers on basic password protection. Typically there exists a single password for a document and it unlocks the document in all-or-nothing fashion. Somewhat less typically, an application like the Adobe Acrobat application (the full version—not the Reader version) supports two levels of passwording, for roles of both a user and a system administrator. The roles differ in that whereas a user can use their password to open the document (but not necessarily print it or edit it), an administrator can open the document as well as reset passwords and override global properties such as read/write status, print protection, and copy/paste enablement, for instance.

While two-level support is better than a single-level, there are still many drawbacks. First, the level of role support in the prior art is coarse. That is, there are at best two roles, but the rights for each role apply globally across all of a document's content (without regard to individual sections). Second, roles are not actually calculated against the identities of the accessing party. A password is all that is needed, regardless of whether the provider of the password is actually the person corresponding to it. It is assumed that if the user has the correct password, he/she must be in the correct role. But this has various problems in that: 1) the user's role may have changed between the time the password was granted and the time it was used; 2) the user's identity is not checked against the asserted role; and 3) as stated before, the scope of the password is for the document-as-a-whole, not interior portions of content. It is also hard, in general, to bring access to redacted content under policy control in a governance sense, because “governance events” tend to occur at the level of resource access (document or folder access), not at the level of access to particular data items within documents.

Third, many techniques used to appropriately promulgate sensitive materials consists of providing many versions of the same content, with only the appropriate party having access to their appropriately-authorized portion. This creates multiple versions of a document for multiple audiences, which complicates security.

In view of these various problems which are not adequately addressed by current art, there is need in the art of sensitive materials to feasibly control access to various interior portions of a document. There is a further need to allow access on just-in-time calculations of user entitlements through a mechanism, including the ability to log and monitor such events. Reducing the number of versions of a document that need to be created and circulated, and also eliminating complex dynamic content-filtering schemes per different users, in which complex, highly tailored documents must be pulled together on the fly, is another noteworthy objective. While no document technology exists that can guarantee that sensitive content, once unlocked, will not be misused by humans, it remains desirable in today's world to show that reasonable precautions have been taken, in the design of software, to deter content theft, mitigate harmul outcomes related thereto, etc. Thus, governance and audit-trail or “chain of custody” notions are other notions to be considered. Naturally, any improvements along such lines should further contemplate good engineering practices, such as relative inexpensiveness, stability, ease of implementation, low complexity, flexibility, etc.

### SUMMARY OF THE INVENTION

The above-mentioned and other problems become solved by applying the principles and teachings associated with the hereinafter-described role-based access to redacted content. In a basic sense, the invention provides techniques for implementing role-based access control over redacted sections of documents (or other material, such as images, video, etc. (collectively, content)), on a per-role/per-section basis, while also allowing such access to be monitored and controlled in real time in an identity infrastructure. Redactions are seen as unlockable chunks that can be viewed/manipulated in unencrypted form only if a user has appropriate role-based privileges.

Example: Bob, Mary, and Mitchell all need access to a particular document (which could be a word processing document, a PDF document, a spreadsheet, or some other kind of document). The document might contain a patient's medical information. Mary, as the primary care physician, needs access to the medical history portion of the document but is not entitled to see annotations having to do with the patient's payment history or financial status. Bob, as the hospital's CFO, is entitled to see the payment-history info but is not entitled to see the medical history. Mitchell is the patient. He is entitled to see everything in this document.

Sensitive areas of the document are blacked-out or obscured (redacted). The content is present in the document in encrypted form. Such areas can be unlocked if the person attempting to view the content has appropriate rights. The invention provides mechanisms whereby users with different rights can unlock and see just the portions of a document they are entitled to see based on their role (and do it in a way that can be monitored, logged, and audited in a highly govemanced environment).

In terms of security, a basic assumption exists that a user who has a legitimate right to gain access to a document, or to a portion of a document, is not malicious and will not misuse his or her privileges. Nevertheless, the invention is mindful of the desirability of discouraging and/or monitoring the unauthorized use of unlocked content, and certain features are designed with that in mind.

In a representative embodiment of usage, an author designates portions of content as to-be-redacted. The author establishes various users roles able to access it and defines attributes or time constraints affecting the viewing/using. Upon electronically saving the content, the to-be-redacted portion is encrypted. An intermediary, such as a keytable service, mediates access between later users and the content. Upon identification of a role of a user attempting to interact with the content, and matching the role to one of the author-established roles, the encrypted redacted portion is decrypted. Otherwise, access to the encrypted redacted portions are prevented but not the remainder of the content. In this manner, users gain access to content based only on their role and adds robustness heretofore unavailable. The surrounding events are also loggable, traceable, and verifiable.

In another usage example, a first user of a software program, in the form of (for example) a spreadsheet software application, has the title or identity of president in an organization and therefore has need of knowing the final budgets of departments under his command, and is (by virtue of role) duly entitled to know such information. Each department head of the organization, e.g., second, third, fourth, etc. users of the spreadsheet software application, need not know (and may in fact be forbidden, by formal organization policy, from knowing) the budget totals of other departments. Thus, the president has need of a software product calculating and showing totals of all rows, columns, etc. of the organization, whereas an individual department head only has need of calculating and showing totals of all rows and columns, etc. for his (and only his) department. Thus, the same software program (e.g., the spreadsheet software application) has different users with different needs and entitlements (the needs/entitlements being defined by policies of the organization that require the president to have an all access pass while each department head only has a limited access view). Being able to control access to the spreadsheet software application with different capabilities or features per each of the different users, per policy, and in recognition of a given individual's role, then has usefulness not afforded by the prior art. It is further an aspect to allow this control according to the authoring stage of the content.

In a computing system environment, the invention may be practiced with a first computing device interacting with a computer program product that allows an author to designate portions of the content as redacted, with the product including allowing the author to establish access indicia to the redacted portions by way of various user roles and according to any attributes or time constraints. A mediation computing device, different than the first computing device, but connected to the first computing device, interacts with a user of the redacted content to identifying a role of a user attempting to interact with the content. If the role of the user matches one of the author-established user roles, the mediation computing device decrypts the encrypted redacted portions. Otherwise, the mediation computing device prevents access to the encrypted redacted portions, but still allows the user to view/use the unencrypted portions. Either the first or mediation computing device are configured to encrypt the redacted portions upon an indication by the author to electronically save the content. A third computing device, the same or different as the first computing device, interacts with the mediation computing device in a monitored connection (including or nor a heartbeat message) that only allows access to the redacted content to occur upon timely transmissions and receipts by the two devices, e.g., a time-responsive manner.

Computer program products are also disclosed. For instance, a product available as a download or on a computer readable medium has: 1) a document space for display on a monitor for an author to visually see content created in the document space; 2) a visual interface for display on the monitor for the author to designate a portion of the content created in the document space as redacted and to designate various users roles able to access the redacted portion; 3) a saving component causing local or remote encryption of the redacted content upon receipt of an indication from the author to electronically save the content; and 4) a displaying component to visually show the user, attempting to interact with the content, the redacted portion in encrypted form if the role of the user does not match one of the designated various user roles. Among other things, this overcomes the prior art's document unlocking in all-or-nothing fashion.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing environment for role-based access to redacted content;

FIG. 2 is a high-level flow chart in accordance with the present invention for role-based access to redacted content;

FIG. 3 is a flow chart in accordance with the present invention of a more detailed process for role-based access to redacted content, including representative authoring of the content;

FIG. 4 is a flow chart in accordance with the present invention of a more detailed process for authoring the redacted content;

FIG. 5 is a flow chart in accordance with the present invention of a representative process for role-based access to redacted content, including encryption upon saving the content;

FIGS. 6A and 6B are flow charts in accordance with the present invention of a more detailed process for role-based access to redacted content, including interacting with the content post-redaction;

FIG. 7 is a flow chart in accordance with the present invention of a more detailed process for role-based access to redacted content, including decryption of the content;

FIG. 8 is a diagrammatic view in accordance with the present invention of a representative form of redacted content;

FIGS. 9 and 10 are diagrammatic views in accordance with the present invention of representative user interfaces to establish access indicia to the redacted content upon authoring the content;

FIG. 11 is a diagrammatic view in accordance with the present invention of a representative user interface to establish a mediation service between a user and the redacted content; and

FIG. 12 is a diagrammatic view in accordance with the present invention of a representative dialog for user options to interact with the redacted content.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for accessing redacted content per user roles are hereinafter described.

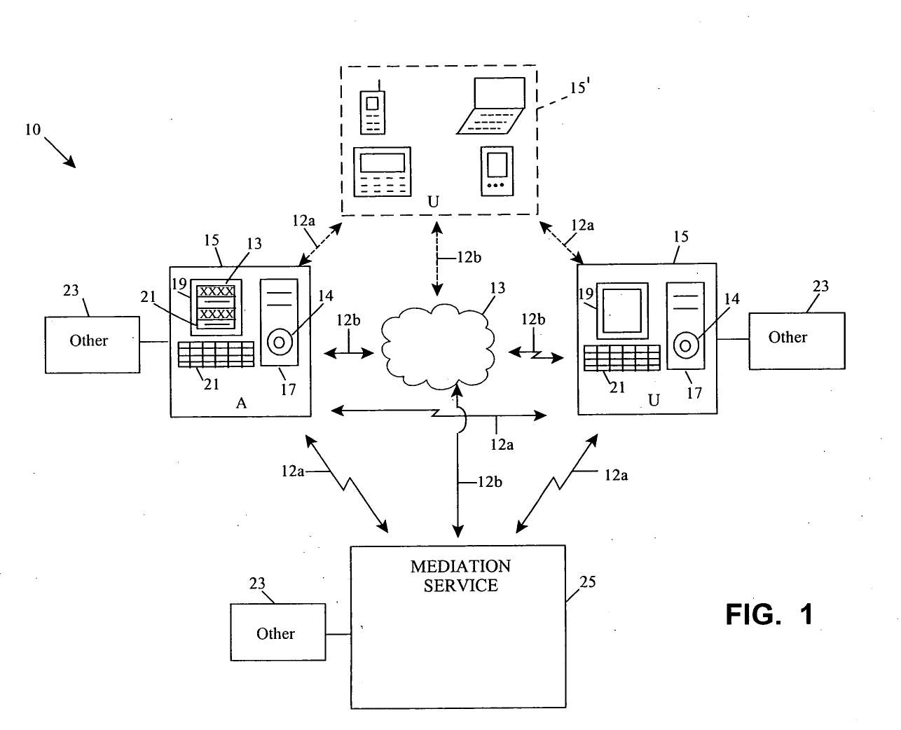

With reference to FIG. 1, a representative computing environment 10 for accessing redacted content consists of one or more computing devices 15 or 15′ available per authors and/or users of redacted content 13, such as in a document 21. The computing devices are also available to a mediation service 25, described below. In a traditional sense, an exemplary computing device typifies a server 17, such as a grid or blade server. Alternatively, it includes a general or special purpose computing device in the form of a conventional fixed or mobile computer 17 having an attendant monitor 19 and user interface 21. The computer internally includes a processing unit for a resident operating system, such as DOS, WINDOWS, MACINTOSH, VISTA, UNIX and LINUX, to name a few, a memory, and a bus that couples various internal and external units, e.g., other 23, to one another. Representative other items 23 include, but are not limited to, PDA's, cameras, scanners, printers, microphones, joy sticks, game pads, satellite dishes, hand-held devices, consumer electronics, minicomputers, computer clusters, main frame computers, a message queue, a peer machine, a broadcast antenna, a web server, an AJAX client, a grid-computing node, a peer, a virtual machine, a web service endpoint, a cellular phone or the like. The other items may also be stand alone computing devices 15′ in the environment 10 or the computing device itself.

In either, storage devices are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., software, as part of computer program products on readable media, e.g., disk 14 for insertion in a drive of computer 17. Computer executable instructions may also be available as a download or reside in hardware, firmware or combinations in any or all of the depicted devices 15 or 15′.

When described in the context of computer program products, it is denoted that items thereof, such as modules, routines, programs, objects, components, data structures, etc., perform particular tasks or implement particular abstract data types within various structures of the computing system which cause a certain function or group of functions. In form, the computer product can be a download or any available media, such as RAM, ROM, EEPROM, CD-ROM, DVD, or other optical disk storage devices, magnetic disk storage devices, floppy disks, or any other medium which can be used to store the items thereof and which can be assessed in the environment.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include servers, routers, peer devices, modems, T1 lines, satellites, microwave relays or the like. The connections may also be local area networks (LAN) and/or wide area networks (WAN) that are presented by way of example and not limitation. The topology is also any of a variety, such as ring, star, bridged, cascaded, meshed, or other known or hereinafter invented arrangement.

With the foregoing representative computing environment as backdrop, the invention can be implemented in any conventional desktop application that allows document authoring and using or viewing (word processing applications, spreadsheet applications, and so forth). It is common for such applications to support an online mode in which a connection is made to remote server, for example to register a product, check for updates, check for license expiration, etc. The invention leverages this connectivity to apply SOA-friendly techniques to the management of access to redacted content, such as by way of the mediation service.

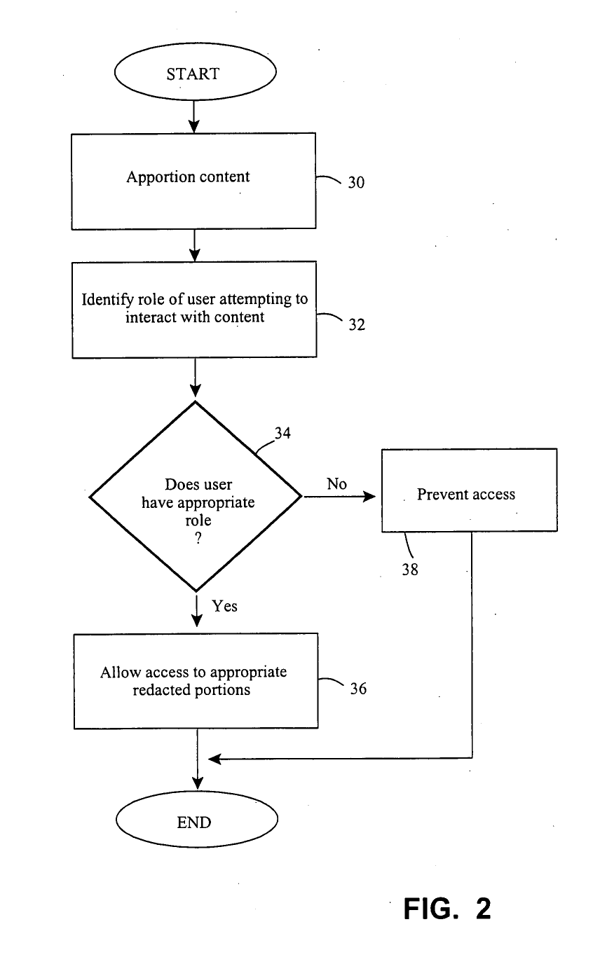

With reference to FIG. 2, a representative embodiment of the invention is in two parts: a set of authoring functionalities (for designating and encoding redacted content as it is being created or edited), and a set of user functionalities for unlocking and decoding redacted content. At step 30, the functionalities for either the authoring or using are embodied in the apportionment of the content. Namely, an author apportions those portions of his content that he wants redacted or a user views an already-created document having been so apportioned. Also, the content may be typified in materials, such as a document with original expression (e.g., a spreadsheet, a word processing document, etc.), an image, audio, video, attachments, or the like.

At step 32, upon a user attempting to interact with the content, their role is identified. As will be seen below, the identification may occur by way of a mediation service, or by way of an active portion of the content itself. The role of the user could be varied. Representatively, it could be that as found in an corporate organization, such as an officer, manager, accountant, salesman, secretary, etc., in a government entity, such as judge, clerk, mayor, police officer, etc., in a sporting team, such as pitcher, catcher, or a more informal identity as would be found in a club, such as singer, dancer, etc. Of course, skilled artisans can contemplate others.

At step 34, if the user's role is an appropriate role for accessing redacted content after the apportionment, access to the redacted portion is allowed at step 36. Otherwise, access is prevented at step 38. However, access to the un-redacted portion of the content is still viewable/usable by the viewer. In this manner, users gain access to content based only on their role and adds robustness heretofore unavailable. It overcomes the prior art's document unlocking in all-or-nothing fashion. The surrounding events are also loggable, traceable, and verifiable.

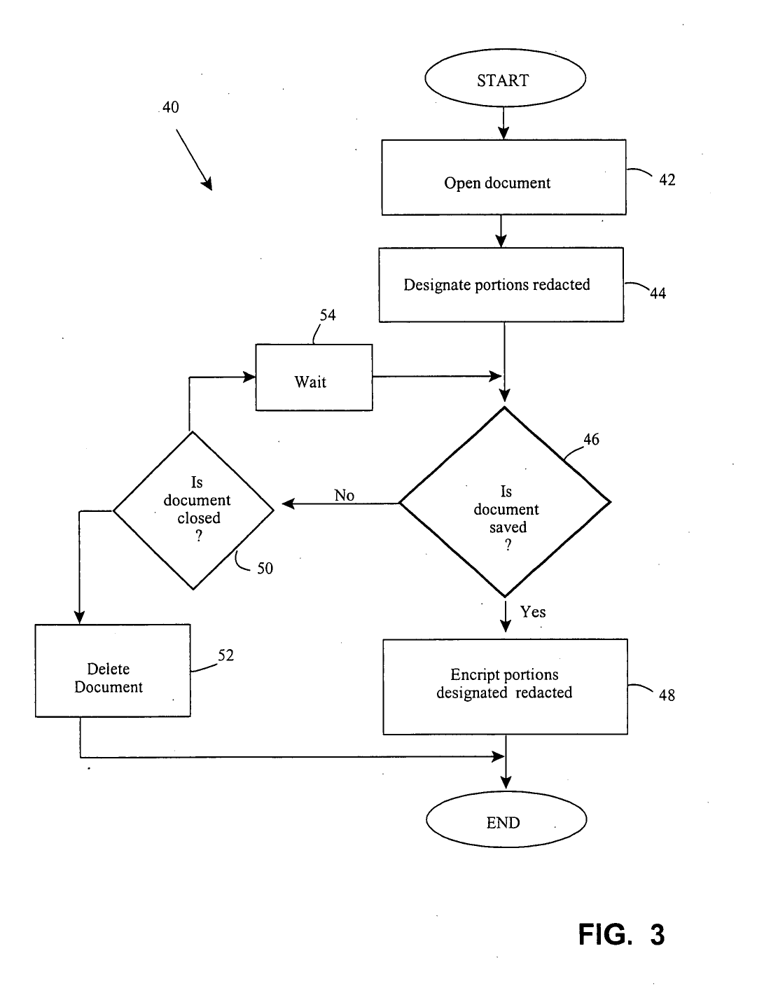

With more detail, FIG. 3 shows an illustrative embodiment for authoring the content of an apportioned document. At step 42, a document (or other content) is opened on a workstation in the computing environment. At step 44, portions of the document are designated by the author as to-be-redacted. In the event the document is electronically saved, step 46, those portions designated for redaction are so redacted, such as by encryption (step 48). On the other hand, if the document is not saved, an inquiry occurs as to whether the document is designated as being closed, step 50. If the author indeed closes it, the document is altogether deleted from memory, step 52. If the document is not yet closed, a period of waiting occurs, step 54, to determine if the document will be later saved at step 46. The process then repeats.

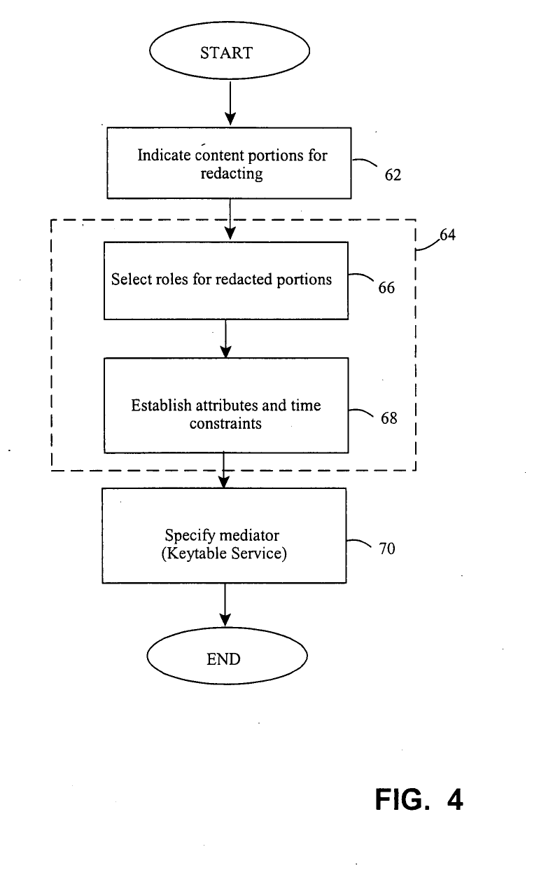

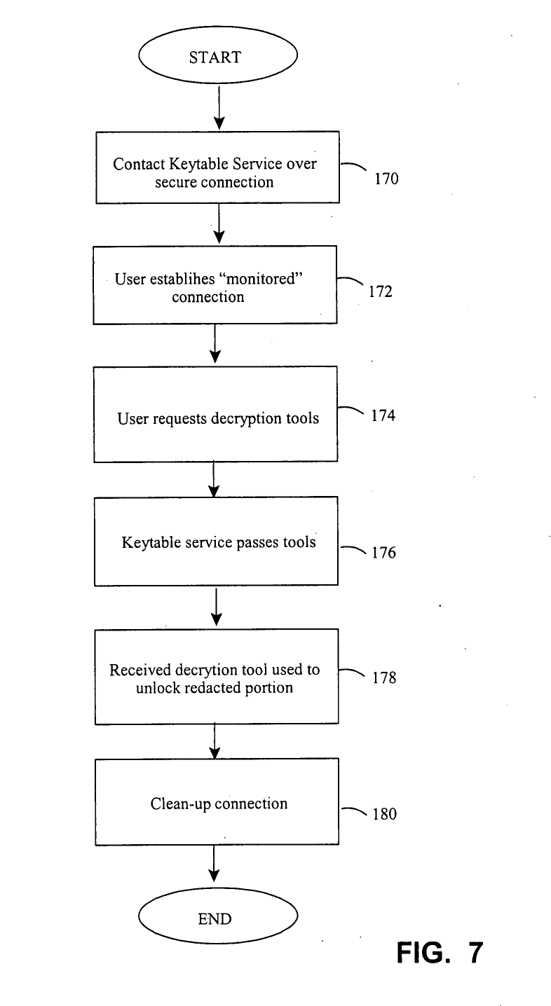

In still a more detailed version of authoring (FIG. 4), the indication of content portions for redacting, step 62, causes the author certain administrative responsibilities. First, the author needs to precisely indicate portions of the content that require redaction. As seen in FIG. 8, such can be indicated in a document 21 by highlighting text 82 in a document with a cursor, providing identification by pages and line numbers 84, 85, by columns and rows in a spreadsheet, etc., or perhaps by section arrangement A., B., C, D., etc., in an outline format. Document 21 also represents a document viewable/usable later by a user and shows both encrypted (A. and C.) and unencrypted portions (B. and D.) within a single document. Of course, if the user had full access, no portions would remain encrypted.

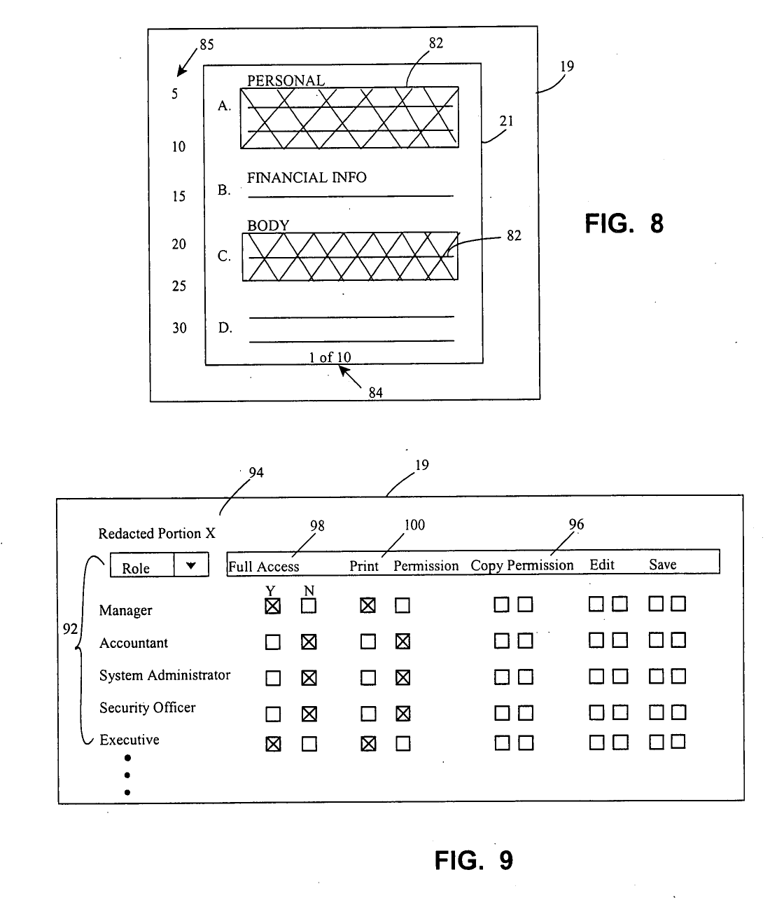

Regardless of how indicated, the establishment of access indicia to the content occurs at step 64 (seen as dashed line, FIG. 4). At step 66, access indicia means selecting various user roles able to access the redacted portions. At step 68, it means establishing attributes and time constraints, if any, for the user roles. For example, FIG. 9 shows a user interface 90 for display on a monitor that enables indication of various roles 92 per each indicated redacted portion 94 of the content. By simple checking of boxes, the author can make each portion viewable, or not, to a user role. Attributes 96, on the other hand, give certain functionality to the users. In the example, a manager and executive role are given “Full Access” 98 to “Redacted Portion X” 94, including “Print Permission” 100. On the other hand, the accountant, the security officer and the system administrator roles have no attributes of any type. In FIG. 10, the time constraints are entered by simple interface 102, and indicate first the existence of a constraint 104, and what that constraint is 106. As shown, the constraint exists for 30 minutes of viewing the redacted portion, by way of entry in a drop-down menu. Of course, skilled artisans can contemplate a near infinite variety of scenarios for access, attributes and time constraints, including those listed in the summary of the invention section. As will be seen below, certain advantages exist by specifying access in this fashion.

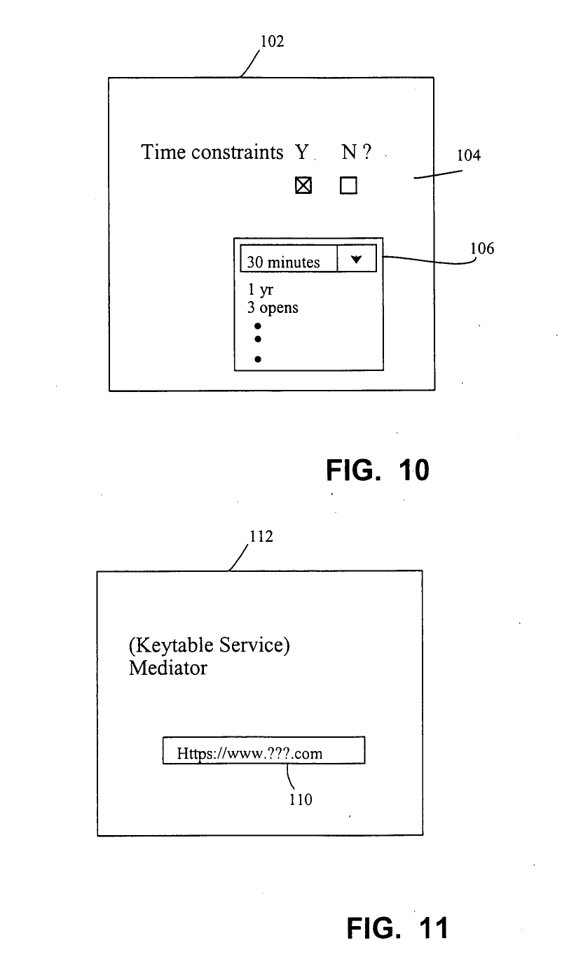

Turning back to FIG. 4, upon the establishment of the access indicia, the author may also specify an intermediary or mediation service 25 (FIG. 1) acting as a gateway between the content and the user attempting to interact with it, step 70. In one instance, the mediation service is a keytable service and such is entered as a URL 110 in an interface 112, FIG. 11. In another, it is a URI. Alternatively, it may be specified by the entity relating to the author or by way of an employers, such as by way of corporate policy, and such may or may not be alterable by the author. In any event, a mediation service is somehow established during the process.

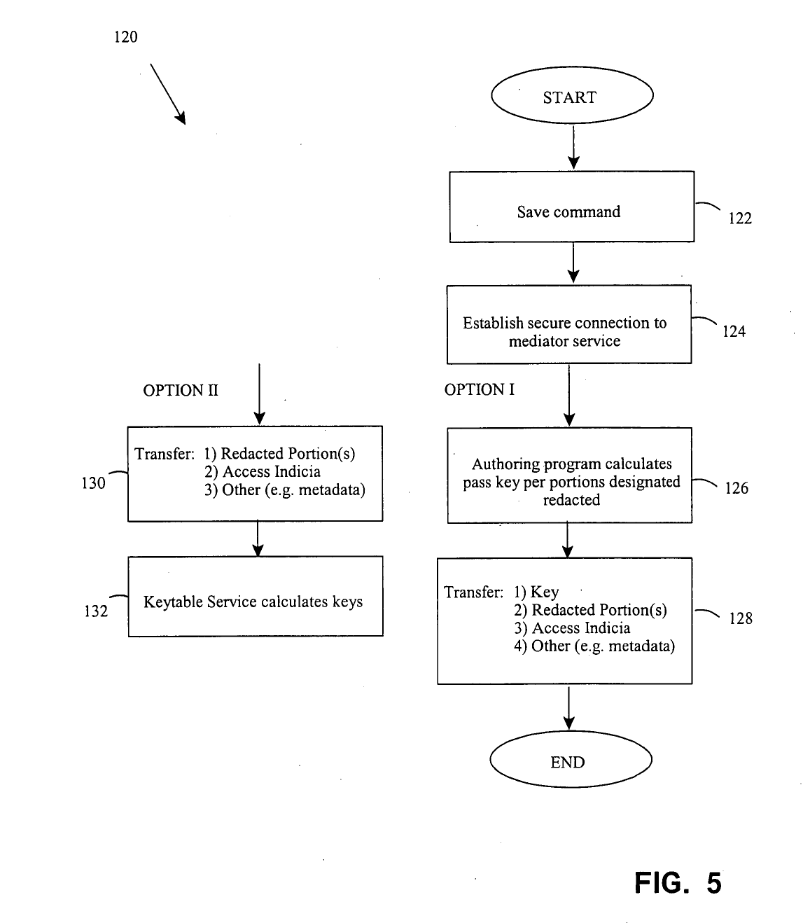

With reference to FIG. 5, a process 120 for encrypting the to-be-redacted portion of the content begins upon issuance of an electronic save command 122, as before. At such time, a secure connection between the computing device of the author and that of the mediation service is established at step 124. In a first option, the authoring program itself calculates passkeys for the portions designated as redacted and passes the keys, the redacted portions, the access indicia and other, if any, to the mediation service, steps 126, 128. Alternatively, the authoring program passes the redacted portions, the access indicia, and other, if any, to the mediation service, where keys are then calculated for the redacted portion by the service, especially a keytable service, at steps 130, 132. At this point, the redacted portion is ready to be interacted with by potential users.

Recapping, however, the following is general about the authoring functionalities:

1. Ability for an author of a document to select a section of the document and designate it as “redacted.” (When the document is later saved, any areas so designated will be encrypted, following mechanisms described further below.)

2. Ability for the author to select a redacted area and apply role constraints to it. For example, the author can choose to apply one or more organizational roles to a selection, meaning that only a person acting in one of those roles can view the redacted text. (It will be appreciated that although the word “text” of a “document” is used here, and elsewhere, the area in question can actually be an image, an audio annotation, a form control, an attachment, or any other kind of content that can exist in a given document; or a combination of such content types treated as a group.)

3. Ability for the author to set attribute values (for things like write permission, print permission, and copy/paste permission) on the redacted area, on a per-role basis. So in other words, through an appropriate UI mechanism, the author of the document will be able to specify that a person in the role of Security Officer is able to print an unlocked piece of the document whereas no one in any other role can print the unlocked text. The same redacted content may very well be accessible to, say, a Manager for viewing, but not for printing. To a non-Manager who is also not a Security Officer, the redacted area will either be blacked out, or it will be invisible so that the user doesn't even know that the redaction exists.

4. Ability for the author to specify a session-based time-to-live value for redacted content during a viewing session. For example, the author may decide that a given piece of redacted content, once unlocked, should remain unlocked for no more than 30 minutes at a time, such that if the viewer of the document leaves his desk (to go to lunch, say) without closing the document, the restricted content “times out” and reverts to its fully redacted appearance.

5. The ability to specify a URL or other address to which requests involving access to redacted content may be delegated. (This might actually be under the control of a system administrator, who sets the URL in a configuration parameter somewhere, eliminating the need for the user to specify it directly.)

6. A service, whose endpoint is the URL just mentioned, hereafter called the keytable service, for example. The responsibilities of this service will be discussed in detail further below.

7. Program logic (either incorporated into the core program or one of its library modules, or as a plug-in, etc.) that accomplishes the following: When the author of a redacted document issues the Save command, the program will (as part of the Save) establish a secure connection to the keytable service mentioned previously. In one embodiment, the authoring program calculates a passkey for each role associated with each piece of redacted content; and that key, along with a role identifier for it, and the document ID (and/or other metadata), are sent to the keytable service for storage. Hashed versions of the role-based passkey(s) are stored in the document itself, and redacted regions of content are encrypted using the various hashes. In another embodiment, the authoring program merely sends (for each redacted region) a role identifier and document ID (and/or other metadata) to the remote keytable service. The service, in turn, calculates a passkey for each role and sends the hashed value(s) back to the authoring program for storage in the document. Every redacted piece of content is encrypted using the appropriate hash, then the document is finally saved. The keytable service stores the unhashed version of each passkey for later retrieval, each key being associated with a role, and the entire collection of keys and roles being associated with the document ID so that the collection can be looked up by document-ID later.

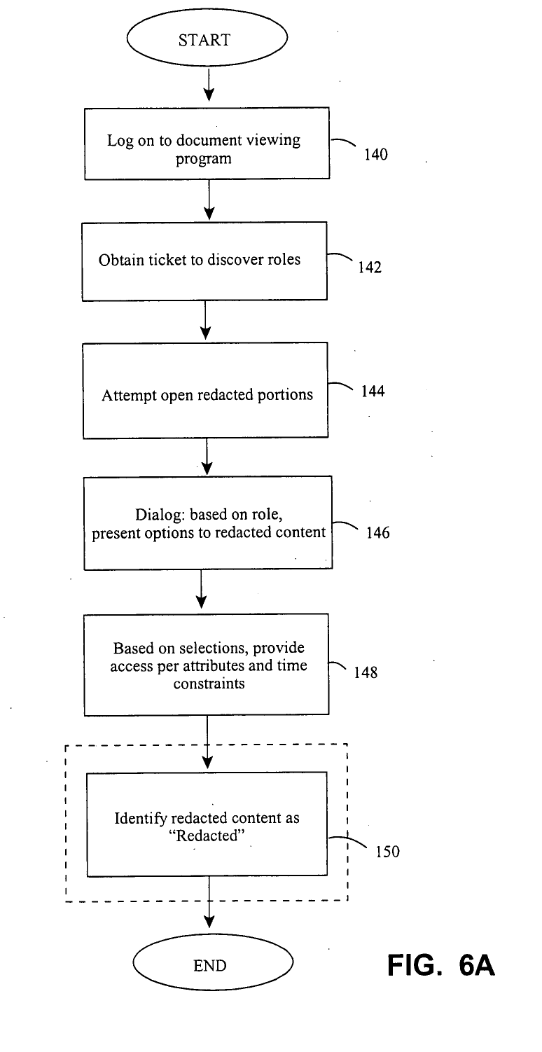

Turning to FIGS. 6A and 6B, various options for a user of the redacted portions are presented. At step 140, a user logs-on to a document viewing program, e.g., by way of OpenOffice (or the viewing program, whatever it happens to be). At the time the program is launched, at which point the program, by virtue of Kerberos-based federation into an identity infrastructure (or an equivalent mechanism), obtains a ticket or other device via which the user's role privileges can be discovered, step 142. When the user attempts to open content containing redactions 144, the program tries to match the author-specified user roles and requirements against the known roles in which the user can act. If the user cannot act in any of the roles dictated by the redactions, the document simply opens and displays whatever content is available for public viewing. If, on the other hand, the user meets the role requirements of at least some redactions, a dialog appears at step 146, informing the user that the document contains redacted content that he/she is eligible to see.

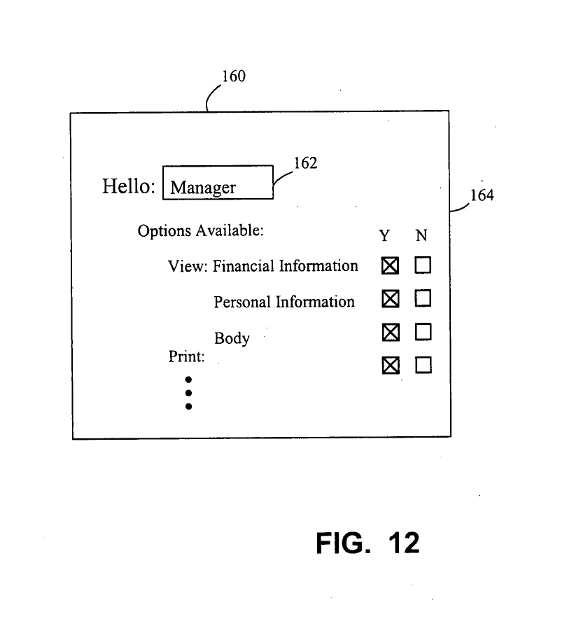

As in representative FIG. 12, the dialog 160 presents a list of roles 162 in which the user can act while viewing the document (the roles that will check-boxes 164 (or other multi-selection UI widget). The user makes role selection(s), after which the dialog disappears and the document opens, displaying content appropriate for the user's privileges, step 148, FIG. 6A. (Decryption of the redacted content will happen in accordance with mechanisms described further below.) In an optional step, 150, the content may identify the redacted portions as actually redacted so as to inform a user of that which is sensitive material.

In another type of embodiment, FIG. 6B, the user launches or logs-on to the viewing program 140 (e.g. OpenOffice) anonymously, then opens a document unchallenged and discovers (while browsing the document) that there are blacked-out content areas (e.g. 82, FIG. 8), step 151. Upon clicking such an area (or by some other triggering mechanism) a dialog appears, challenging the user for credentials that will allow the user's role privileges to be determined, step 153. (The program can also contact a role service to determine this.) Based then on the user's known privileges, all of the redactions that the user is entitled to see are unlocked, step 155, especially according to the attributes and time constraints earlier specified.

In sum, it can be appreciated that calculation of the user's role can happen transparently, if the user has previously authenticated to a single-signon infrastructure in which the components of the invention are federated; or can happen through a challenge; said challenge can occur at the time of document opening, or at the time a redaction is clicked; and the actual role calculation can take place on a (real or virtual) server that is not necessarily the same one that hosts the keytable service. The important thing is that the user will, at some point, undergo a role-sufficiency check before being allowed to view restricted content.

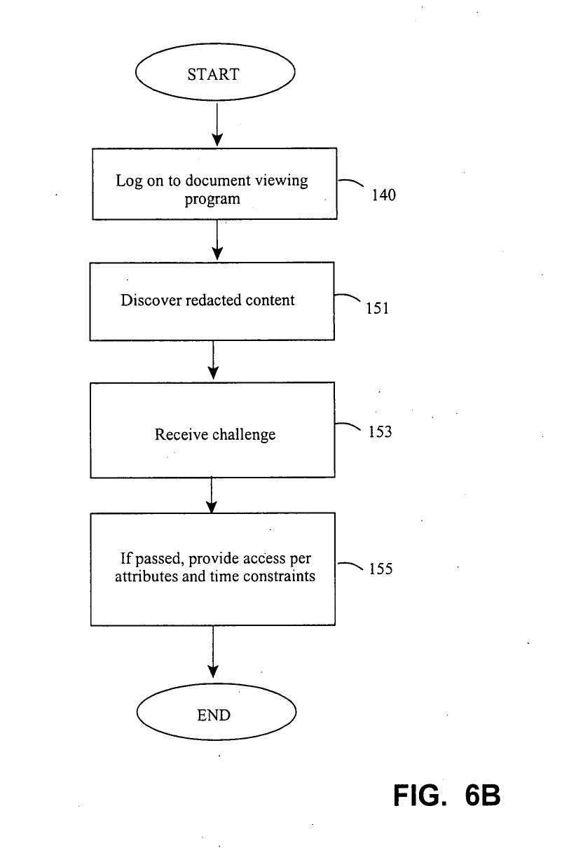

With reference to FIG. 7, the actual unlocking or decryption of redacted content occurs through the following mechanisms.
A. Within the document or in the viewing program's config settings exists a URL or other address pointing to the mediation or keytable service. The program contacts the service over a secure connection, step 170, and provides the service with a document ID and/or such other information (e.g., a Kerberos ticket) as may be required in order to continue (Footnote: The keytable service can do a role check if one has not yet occurred, but it can be assumed that by now, at least in some embodiments, the user will have passed a role challenge and is known to be qualified to act in certain roles; and this information has been duly asserted to the key service.
B. Before any further action takes place, the user program establishes a monitored connection with the mediation service, step 172. In a typical embodiment, a heartbeat pulse is established with the keytable service, e.g., the keytable service creates an instance of a watchdog timer and the program on the computing device of the user agrees to send a heartbeat message to the remote service once every Nseconds, or in some other timed-responsive fashion. If the client fails to timely transmit, the mediation service, remote service tears down the connection (and probably logs the event).
C. Among the heartbeat message or pulse to the mediation service is a payload that contains one or more of:
   I) A log of events registered by the program in response to user actions;
   ii) A timestamp;
   iii) A nonce; or
   iv) Whatever other information may be required by policy or is otherwise deemed useful.
D. The computing device of the user and the mediation service wait until a heartbeat is properly established before proceeding. From this point on, if the heartbeat is interrupted, each process knows to terminate. (The client, e.g., user, will return the document to a safe state as part of the termination.)
E. Optionally, the client-side software may silently taint the document at this point with hidden information (such as a traceable nonce) which could be of forensic help later in determining the chain of custody of the document. In at least one embodiment, client-side logic will remove the taint at the close of the session if the session finishes normally.
F. An embodiment may also use a technique of injecting a “time bomb” (delayed poison pill) into the viewing program. At each heartbeat interval, the client software resets the delay on the bomb so that it does not go off. If the session ends normally, client-side logic simply removes the bomb. But in the event of abnormal session termination, the bomb goes off (causing the document to close or some other action to occur).
Note: This feature could be implemented in such a way that the antidote to the poison pill is known only to the server-side process, i.e., the client cannot, even in theory, remove the pill (or defuse the bomb) on its own. Also note: Individual time-bombs may be targeted at individual redactions as a way of enforcing the “time to live” attribute on each redaction (discussed earlier, e.g., FIG. 10).
G. After the user and mediation service participants agree that the preliminary session requirements have been met, the client requests keys corresponding to the various redactions the user is entitled to see, step 174. In response, the keytable service uses the passed-in document ID to locate the key(s) for the document and the keys are sent to the requester, step 176.
H. On the client side, the received keys are used to unlock the redacted portion, step 178. In an embodiment, the keys are hashed one by one and compared to the various hashes that were stored in the document (corresponding to the various role-based redactions). As seen in FIG. 9, for example, a Redacted Portion “X” 94 is one such portion. Other portions will have corresponding roles, attributes and/or time constraints therewith.
I. For each hash that matches its redaction-hash counterpart, the corresponding content is decrypted and made displayable, either immediately or pending successful completion of the following steps.
   i) Client logic checks the capability profile (for attribute privileges like “can print,” “can edit,” “can save,” etc.) associated with each unlocked redaction and calculates the overall set of constraints that must be applied on the document for this session. (Note: This step could involve consulting a policy service.) The resulting set of constraints is applied to the viewing program using published or unpublished APIs, or by patching traps or vector tables, or using whatever means necessary; and confirmation of the success of this step is sent in an outgoing heartbeat payload. The keytable service waits for this confirmation, and if it is not received, it terminates the session.
   ii) Optionally, and in an embodiment, the user plug-in will instrument the viewing software with event listeners designed to capture user actions of interest (such as Copy, Paste, Save, particular menu commands, etc.) so that it can thereafter send a record of said events to the keytable service in heartbeat payloads, affording a near-real-time monitoring of said events by the server process. (Alternatively, the events may be sent to a logging service, or to some other third party agent.) In this manner, silent monitoring can occur and a record kept of whether the user used the Copy, Cut, or Paste commands, tried to save the document under different file names, tried to modify redacted content, or attempted actions deemed suspicious for whatever reason. Thus, suspicious conduct with respect to a redacted document is detected in near-real time and action can be taken immediately. Of course, other monitoring can occur without notions of suspicious conduct for later logging/auditing of events.
   iii) In at least one embodiment, protected or redacted content is unlocked “lazily,” such that redactions are decrypted when (and only when) the user scrolls such content into view onscreen of a monitor; otherwise the decrypted content is overwritten in memory as quickly as possible. Likewise, keys are overwritten as soon as they are used, and re-fetched from the keytable service as needed. This tactic ensures that the client must maintain a live connection to the key server at all times in order for the user to interact with the document. If the connection to the key server is suddenly lost, protected content remains protected until a new connection is established. (Also, the capability profile of the program with respect to the document remains frozen in whatever state it was in.) Another advantage of “lazy unlocking” is that in the event of a sudden change to the user's role status, the keytable service could end the session immediately as a way of revoking the user's privileges on the document in real time.
J. If any redaction was given (by its author) a time-to-live value, e.g., FIG. 10, the client-side logic will enforce that constraint by reverting “timed out” content to the fully redacted state upon reaching the expiration limit. In at least one embodiment, the client-side logic will check for expired content at each heartbeat interval. Expiration events may be reported in the normal event stream.
K. When the user issues a Close Document command, client-side logic closes the document, restores the program's original privilege state, and performs any other “cleanups” that may be needed, then notifies the key service of the successful document closure, step 180. The heartbeat is shut down, the session is closed, the connection torn down, etc.

In various embodiments, the foregoing makes certain assumptions. For instance, it is assumed that all keys are stored and managed at one endpoint (the keytable service URL). It can be appreciated, however, that multiple unique authorization endpoints could be specified for the various redactions in a document, and also that one or more of these endpoints could trigger a workflow or other process, and that the workflow so triggered could involve human intervention, such that the human proprietor of restricted content could be contacted in real time in order to get permission to view the content. For example, a medical document may contain information, in certain form fields, that only the patient can dispense. The viewing physician (who might not be the primary doctor but a consultant on the case, miles away) clicks on a redacted form field; a service endpoint is contacted, which in turn dials the patient's cell phone number; and the patient hears a message and enters a code to authorize the unlocking of the redaction.

Certain advantages and benefits of the invention over the prior art should now be readily apparent. For example, but not limited to, the invention: 1) allows role-based access control to be applied to individual pieces of content within a larger document, rather than (or possibly in addition to) exercising access control at the document level, thereby giving fine-grained access control; 2) contemplates being able to federate role-restricted redactions into a SSO environment; 3) enables unlocking role-differentiated content in real time, in response to user actions, while the user is actually viewing a document; 4) allows revoking user privileges on role-restricted content in real time; 5) automatically “times out” in accordance with a set TTL value (as a security precaution to limit unnecessary exposure of sensitive content) and enables specifying TTLs on a redaction-by-redaction basis; 6) enables the notion of applying role-tailored attribute constraints (with respect to printing, editing, saving, copying, pasting, etc.) to a viewing program, under realtime control of a remote service (which could be a policy service); 7) contemplates cases where attempting to access a piece of content that is redacted triggers a workflow (which could in turn trigger anything from a text message by cell phone, an audio phone call, an IM ping, an e-mail transmission, or almost anything) involving human intervention by a content proprietor; 8) contemplates application to sub-regions of images in larger images created using Illustrator or Photoshop or a like program. Of course, these are only a few of the many advantages of the invention and skilled artisans will immediately recognize others. In still other embodiments, the practice of the invention could be adapted to web pages or other online content by applying a role-based view to content through access to WebDAV annotations. The uses for this, however, would probably be of a slightly different type than for the word-processing and other offline document scenarios described mostly above.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. In a computing system environment, a method of providing access to redacted material, comprising:
designating a portion of content as redacted, including establishing various users roles able to access the redacted portion, the establishing occurring by an author of the content;
upon electronically saving the content, encrypting the redacted portion;
identifying a role of a user attempting to thereafter interact with the content; and
if the role of the user attempting to interact with the content matches one of the established various user roles able to access the redacted portion, decrypting the encrypted redacted portion, otherwise preventing access to the encrypted redacted portions but showing portions of the content other than the encrypted redacted portions.

2. The method of claim 1, wherein the encrypting the redacted portion includes passing the redacted portion and the established various user roles to a keytable service that mediates access between the user and the content.

3. The method of claim 1, further including establishing attributes and time constraints for the user relative to the content.

4. The method of claim 1, further including establishing a monitored connection between a plurality of computing devices, wherein providing access to the decrypted redacted portion only works when the computing devices actively communicate with one another in a timed fashion.

5. The method of claim 1, further including providing a set of options to the user for accessing the redacted portion, the providing occurring before the decrypting the encrypted redacted portion.

6. In a computing system environment, a method of providing access to redacted material, comprising:
at a first computing device, designating portions of content as redacted, including establishing access indicia to the redacted portions by way of various user roles able to access the redacted portions and indicating any attributes or time constraints for accessing the content;
upon electronically saving the content, encrypting the redacted portions;
by way of a second computing device not the same as the first computing device, identifing a role of a user attempting to interact with the content; and
if the role of the user attempting to interact with the content matches one of the established various user roles able to access the redacted portions, decrypting the encrypted redacted portions, otherwise preventing access to the encrypted redacted portions but showing the encrypted redacted portions in the content.

7. The method of claim 6, further including establishing a monitored connection between a plurality of computing devices, wherein providing access to the decrypted redacted portion only works when the computing devices actively communicate with one another.

8. The method of claim 7, wherein the established monitored connection includes periodically communicating a heartbeat message from a third computing device to the second computing device, the heartbeat message having at least one of a timestamp, an event log and a nonce, the second computing device being the same or different as the first computing device.

9. The method of claim 8, further including breaking the established monitored connection if the heartbeat message is not timely received by the second computing device.

10. The method of claim 6, further including logging any of the attempting to interact with the content.

11. The method of claim 6, further including providing a set of options to the user for accessing the redacted portion, the providing occurring before the decrypting the encrypted redacted portion.

12. A computer program product available as a download or on a computer readable medium having executable instructions for performing steps to provide access to redacted material, comprising:
opening a document for an author to create content;
receiving an indication from the author of the content to designate a portion of the content as redacted, including receiving from the author various users roles able to access the redacted portion and receiving any attributes or time constraints relating to interacting with the content;
causing an encryption of the redacted content upon receiving an indication from the author to electronically save the content; and
passing a key to decrypt the encryption of the redacted content and passing the various users roles, attributes and time constraints to a mediation service for decrypting the encrypted redacted content with the key upon matching a role of a user attempting to interact with the content with one of the established various user roles able to access the redacted portion.

13. A computing system environment for providing access to redacted material, comprising:
a first computing device interacting with a computer program product that allows an author to designate portions of content as redacted, the product including allowing the author to establish access indicia to the redacted portions by way of various user roles and according to any attributes or time constraints; and
a mediation computing device not the same as the first computing device but connected to the first computing device for identifying a role of a user attempting to interact with the content, wherein either the first computing device or the mediation computing device is configured to encrypt the redacted portions upon an indication by the author to electronically save the content, and wherein if the role of the user matches one of the established various user roles able to access the redacted portions the mediation computing device is configured to decrypt the encrypted redacted portions, otherwise the mediation computing device prevents access to the encrypted redacted portions but enables showing the encrypted redacted portions in the content.

14. The computing system environment of claim 13, further having a third computing device the same or different as the first computing device in a monitored connection with the mediation computing device including a heartbeat message being sent from the third computing device to the mediation computing device, the third computing device for the user attempting to interact with the content.

15. The computing system environment of claim 14, wherein the mediation computing device is configured to break the monitored connection if the heartbeat message is not timely received by the mediation computing device.

16. The computing system environment of claim 13, wherein the mediation computing device is configured to log attempts of other computing devices attempting to interact with the content.

17. The computing system environment of claim 13, wherein the mediation computing device is configured to provide a set of options to the user for accessing the redacted portion before the decrypting the encrypted redacted portion.

18. A computer program product available as a download or on a computer readable medium having executable instructions for loading on a computing device to regulate access to redacted material, comprising:
a document space for display on a monitor of the computing device for an author to visually see content created in the document space;
a visual interface for display on the monitor for the author to designate a portion of the content created in the document space as redacted and to designate various users roles able to access the redacted portion;
a saving component causing local or remote encryption of the redacted content upon receipt of an indication from the author to electronically save the content, the encryption able to be decrypted upon matching a role of a user attempting to interact with the content to one of the designated various user roles; and
a displaying component to visually show the user, attempting to interact with the content, the redacted portion in encrypted form if the role of the user does not match one of the designated various user roles.

19. In a computing system environment, a method of providing access to redacted material, comprising:
designating a portion of content as redacted, including establishing various users roles able to access the redacted portion according to any attributes or time constraints;
upon electronically saving the content, encrypting the redacted portion;
identifying a role of a user attempting to thereafter interact with the content;
if the role of the user attempting to interact with the content matches one of the established various user roles able to access the redacted portion, decrypting the encrypted redacted portion so long as a monitored connection between a plurality of computing devices is maintained in a time-responsive fashion.

20. The method of claim 19, further including passing the redacted portion and the established various user roles from a first of the computing devices to a second of the computing devices, the second computing device mediating access between the user and the content.

21. In a computing system environment, a method of providing access to redacted material, comprising:
designating portions of content as redacted, including establishing various users roles able to access the redacted portions, the establishing occurring by an author of the content and one portion of the redacted portions being accessible by one role of the various users roles different than another role of the various user roles able to access another portion of the redacted portions;
upon electronically saving the content, encrypting the redacted portion;
identifying a role of a plurality ofusers attempting to thereafter interact with the content; and
per each of the roles of the users, if the role of one of the users attempting to interact with the content matches one of the established various user roles able to access the redacted portion, decrypting the encrypted redacted portion, otherwise preventing access to the encrypted redacted portions but showing portions of the content other than the encrypted redacted portions.
